(19) United States
(12) Patent Application Publication
(10) Pub. No.: US 2003/0232319 A1
(43) Pub. Date: Dec. 18, 2003

(54) Network-based method and system for sensory/perceptual skills assessment and training

(76) Inventors: David Grisham, American Canyon, CA (US); Gordon Epstein, Walnut Creek, CA (US); Maureen Powers, San Pablo, CA (US); Phillip Riles, Sacramento, CA (US)

Correspondence Address: DANIEL P. MAGUIRE, 423 E ST., DAVIS, CA, 95616, US

(21) Appl. No.: 10/426,294

(22) Filed: Apr. 30, 2003

Related U.S. Application Data
(60) Provisional application No. 60/376,867, filed on Apr. 30, 2002.

(51) Int. Cl. G09B 7/00

(52) U.S. Cl. 434/362; 434/247; 434/258; 434/365

(57) ABSTRACT

A method and system for assessment and training of sensory/perceptual deficiencies is disclosed. The present invention includes: (i) an assessment module or system, (ii) training modules, (iii) a centralized database for storing assessment, training, and other data, and (iv) a feedback mechanism for parents, teachers and doctors that allows immediate input regarding either a particular person's data or a group (e.g., class) analysis. The training modules and database can be accessed via the internet or other network, thereby allowing training to occur at times and places that are convenient for the subject. Clinicians, researchers, and educators can conveniently access the database through the internet or another network connection. With convenient access to assessment and training data, clinicians can more easily treat their patients, and researchers can use the database as a resource to help determine the causes and best treatment protocols for sensory/perceptual deficiencies such as Visual Inefficiency Syndrome.

### CROSS-REFERENCE TO RELATED APPLICATIONS

This application is entitled to the benefit of Provisional Patent Application Ser. No. 60/376,867, filed Apr. 30, 2002. The disclosure of that application is incorporated by reference as if set out in full.

### COPYRIGHT NOTICE

A portion of the material in this patent document is subject to copyright protection under the copyright laws of the United States and of other countries. The owner of the copyright protection has no objection to the facsimile reproduction by anyone of the patent document or the patent disclosure, as it appears in the United States Patent and Trademark Office file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of Invention

The present invention relates to the field of sensory/perceptual skills assessment and training.

///

///

///

2. Background Description

Many individuals suffer from deficiencies in perceptual and sensory skills, and these deficiencies impair reading, learning, and other major life activities. For instance, an estimated 25% of all American students have a visual skills deficiency called “Visual Inefficiency Syndrome (VIS).” This syndrome, which results from underdeveloped and undertrained eye muscles, limits the eyes' ability to transmit visual information to the brain, thus impairing reading skills. Without exercise, readers of all ages can develop VIS, but it is most easily detected in school settings. Those suffering from VIS can still see and read, but must work harder to do so, and therefore tend to learn at a slower pace. VIS is distinct from poor visual acuity—a person can have 20/20 (“perfect”) visual acuity, and still not be able to read efficiently due to poor visual skills. Of course, this impairment in reading skills can have a significant negative effect on grade level performance and standardized scores.

Although many schools and other organizations do screen for visual acuity with traditional eye chart tests, these routine screenings have usually not included testing for VIS or other sensory/perceptual deficiencies. Instead, VIS screening and testing has traditionally been available only through doctors' offices, requiring clinical supervision.

VIS and other sensory/perceptual deficiencies can be treated through training and skills development. However, since such training has traditionally been performed in a clinician's office, it can be relatively expensive and inconvenient. In order to begin meeting the tremendous need for sensory/perceptual training, a more convenient and cost-effective delivery system is needed.

### BRIEF SUMMARY OF THE INVENTION

The present invention is an interactive network-based platform for delivery of sensory/perceptual assessment and training to a large number of subjects. Its essential elements include: (i) an assessment module or system, (ii) training modules, (iii) a centralized database for storing assessment, training, and other data, and (iv) a feedback mechanism for parents, teachers and doctors that allows immediate input regarding either a particular person's data or a group (e.g., class) analysis. The training modules and database can be accessed via the internet or other network, thereby allowing training to occur at times and places that are convenient for the subject. Clinicians, researchers, and educators can conveniently access the database through the internet or another network connection. With ready access to assessment and training data, clinicians can more easily treat their patients, and researchers can use the database as a resource to help determine the causes and best treatment protocols for sensory/perceptual deficiencies such as VIS. Thus, the present invention not only reduces the cost and burden of delivering sensory/perceptual skills training and assessment, but it also creates a vast repository of valuable research data.

### BRIEF DESCRIPTION OF THE DRAWINGS

This patent or application file contains at least one drawing executed in color. Copies of this patent or patent application publication with color drawings will be provided by the Office upon request and payment of the necessary fee.

FIG. 1 is a flowchart of a sensory/perceptual skills training and assessment system according to an embodiment of the present invention.

FIG. 2 is a flowchart of a visual skills training and assessment system according to an embodiment of the present invention. FIGS. 2-28 depict aspects of this embodiment.

FIG. 3 is the front side of a Scantron form used during a screening to record measurements of a subject's optical and visual skills variables.

FIG. 4 is the back side of a Scantron form used during screening to record measurements of a subject's visual skills and symptoms.

FIG. 5 is a screen shot showing a login web page, according to an embodiment of the present invention.

FIG. 6 is a screen shot showing a post-login welcome web page, according to an embodiment of the present invention.

FIG. 7 is a screen shot showing an instructions web page for a visual skills training module, “Fast Focusing,” according to an embodiment of the present invention.

FIG. 8 is a screen shot showing a first visual skills training module, “Fast Focusing,” according to an embodiment of the present invention.

FIG. 9 is another screen shot showing a first visual skills training module, “Fast Focusing,” according to an embodiment of the present invention.

FIG. 10 is a screen shot showing a results web page for a first visual skills training module “Fast Focusing,” according to an embodiment of the present invention.

FIG. 11 is a screen shot showing an instructions web page for a second visual skills training module, “Smooth Tracking,” according to an embodiment of the present invention.

FIG. 12 is a screen shot showing the second training module, “Smooth Tracking,” according to an embodiment of the present invention.

FIG. 13 is another screen shot showing a second visual skills training module, “Smooth Tracking,” according to an embodiment of the present invention.

FIG. 14 is a screen shot showing a results web page for a second visual skills training module, “Smooth Tracking,” according to an embodiment of the present invention.

FIG. 15 is a screen shot showing an instructions web page for a third visual screening training module, “Jump Tracking,” according to an embodiment of the present invention.

FIG. 16 is a screen shot showing a third visual skills training module, “Jump Tracking,” according to an embodiment of the present invention.

FIG. 17 is another screen shot showing a third visual skills training module, “Jump Tracking,” according to an embodiment of the present invention.

FIG. 18 is a screen shot showing a results web page for a third visual skills training module, “Jump Tracking,” according to an embodiment of the present invention.

FIG. 19 is a screen shot showing an instruction web page for a fourth visual skills training module, “Cross-Eyed Fusion,” according to an embodiment of the present invention.

FIG. 20 is a screen shot showing a fourth visual skills training module, “Cross-Eyed Fusion,” according to an embodiment of the present invention.

FIG. 21 is another screen shot showing a fourth visual skills training module, “Cross-Eyed Fusion,” according to an embodiment of the present invention.

FIG. 22 is a screen shot showing a results web page for a fourth visual skills training module, “Cross-Eyed Fusion,” according to an embodiment of the present invention.

FIG. 23 is a screen shot showing an instructions web page for a fifth visual skills training module, “Wall-Eyed Fusion,” according to an embodiment of the present invention.

FIG. 24 is a screen shot showing a fifth visual skills training module, “Wall-Eyed Fusion,” according to an embodiment of the present invention.

FIG. 25 is another screen shot showing a fifth visual skills training module, “Wall-Eyed Fusion,” according to an embodiment of the present invention.

FIG. 26 is a screen shot showing a results web page for a fifth visual skills training module, “Wall-Eyed Fusion,” according to an embodiment of the present invention.

FIG. 27 is a screen shot showing a web page summarizing scores for the five visual skills training modules tested during a training session, according to an embodiment of the present invention.

FIG. 28 shows a system architecture including a central database and network applications for a system according to an embodiment of the present invention.

### DETAILED DESCRIPTION

The present invention is an interactive, network-based system for assessing and improving sensory/perceptual skills such as seeing, reading and hearing. Its essential elements include: (i) an assessment module or system, (ii) training modules, (iii) a centralized database for storing assessment, training, and other data, and (iv) a feedback mechanism for parents, teachers and doctors that allows immediate input regarding either a particular person's data or a group (e.g., class) analysis. The training modules and database can be accessed via the internet or other network, thereby allowing training to occur at times and places that are convenient for the subject. The assessment module or system may also be accessed over the internet or other network.

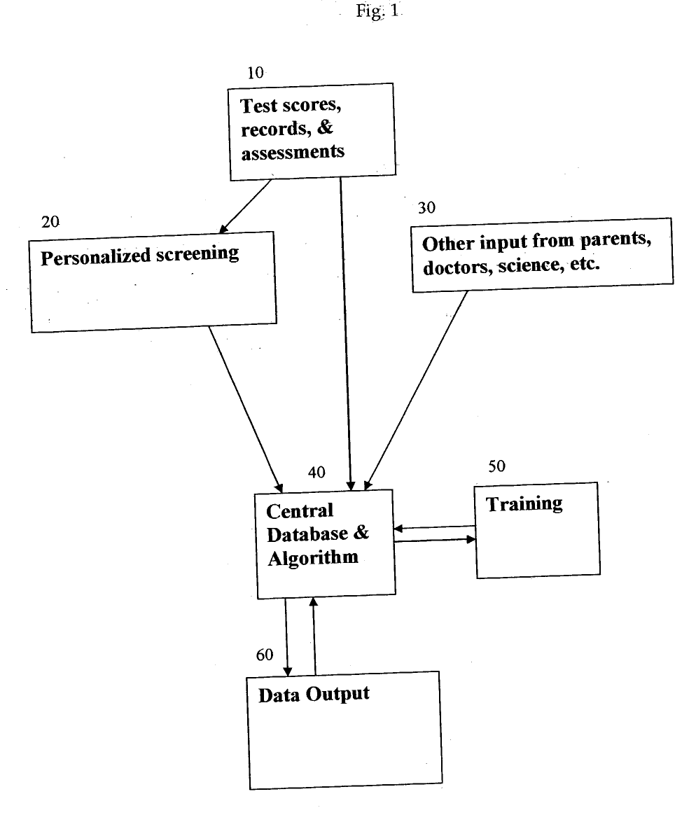

A flowchart describing the present invention is provided with FIG. 1. The first step, as shown in blocks 10 and 20 of FIG. 1, is to gather information about a subject and his or her sensory/perceptual skills. This information can be gathered from test scores, records, and assessments (block 10), and/or personalized screening (block 20). The information gathered in block 10 may include information such as academic records, athletic records, health records, reading or other academic and other standardized test scores. All this information, as well as the personalized screening information from block 20, is entered in a central database, as depicted in block 40. Other input from parents, doctors, and scientific literature may also be added to the central database. See block 30.

An algorithm then evaluates the assessment data described in the paragraph above, and determines which subjects would benefit from sensory/perceptual training. See block 40. Once a subject has been referred to training, he or she can can then access the training modules over a network connection, such as the internet. See block 50. Subject's scores would then be recorded in the central database and would be accessible, remotely or otherwise, by doctors, researchers, educators, and parents. See block 60. The database could monitor future performance of subjects, as well as serve as a vast repository of research data that would further aid the study of learning deficiencies and perception skills training. Id.

The present invention and method can be used to assess and treat many sensory/perceptual deficiencies, including but not limited to: VIS, auditory skills deficiencies, auditory processing; speech therapy, sports vision, dyslexia therapy, reading speed and fluency programs, etc. It can be used in a variety of settings, including (i) educational settings such as schools, (ii) training programs for government organizations and private industry, especially those in which employees must process great quantities of information in print or on a computer, (iii) clinical settings, including the offices of optometrists, ophthalmologists, therapists, psychologists, reading specialists, and adult literacy educators, and (iv) research settings, such as human factors research for high definition computer consoles or research on learning disabilities. A detailed description of an educational-based visual skills embodiment of this invention is provided below, but this description is offered for illustration purposes only, and should not be used to limit the scope of this patent.

Visual Skills Embodiment

This embodiment of the invention is a system for improving the following visual skills: accommodation (also known as accommodative facility, focusing, or dynamic focusing), saccadic accuracy (also known as tracking or saccadic tracking), and vergence (also known as convergence & divergence, or binocular eye teaming).

The first skill, accommodation, is the ability to use muscles inside each eye to rapidly and accurately adjust the lens (like the lens of a camera) to make images sharp and clear. This skill is especially important in copying notes from the chalkboard. The examinations are standard vision tests that are well known in the field, such as: the Modified Clinical Technique (which may include distance visual acuity, binocular balance at near and far, retinoscopy and external eye health); the Developmental Eye Movement test for eye tracking; and an optional Taylor Visagraph recording (which measures a student's binocular reading efficiency). In addition to these tests, other standard exercises measure vergence ranges and near point, accommodative facility and near point, and visual symptoms.

This series of examinations, drills and questions may be performed in a specific order, since some of the tests cause performance-impairing muscle fatigue. Thus, the fatigue-causing tests may be performed last so that they do not influence performance on the earlier tests.

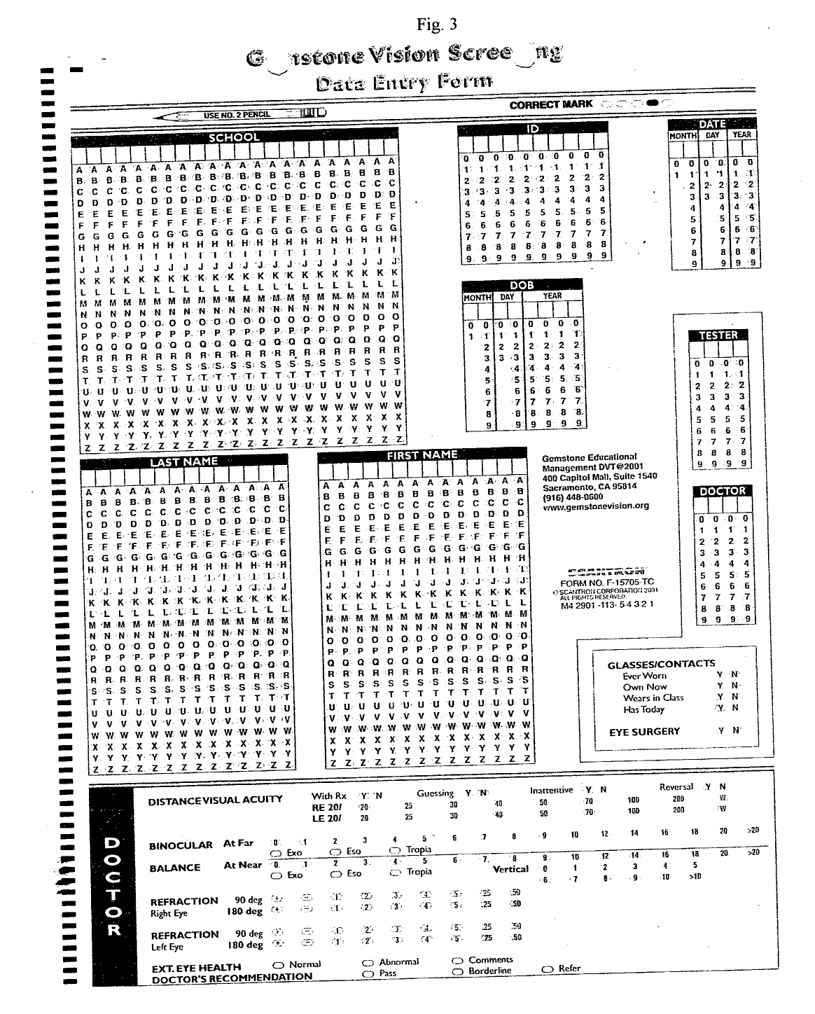

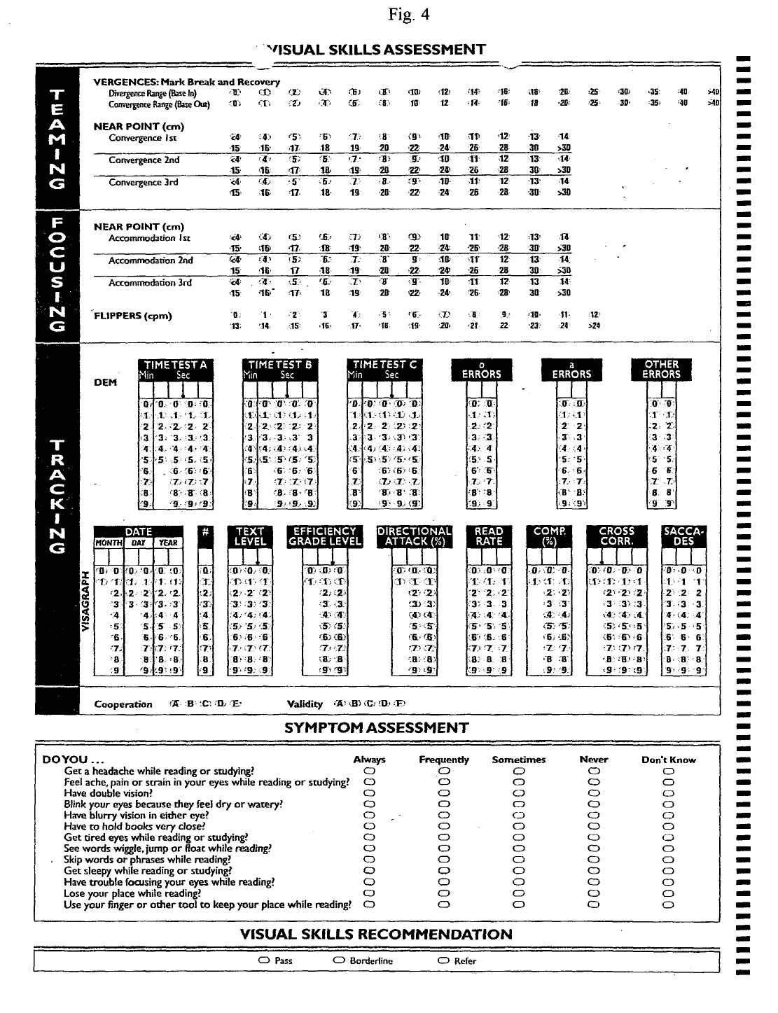

A sample sequence is provided on the customized Scantron form shown on FIGS. 3 and 4. In this sample sequence, information is gathered in the following order:

Preliminary data, such as organization, school, medical or optometric practice name, ID number, date of screening, date of birth, full name, whether the subject has ever, or does now, wear glasses or contact lenses, whether subject wears glasses or contact lenses in class, whether subject has glasses or contact lenses on at the time of screening, and whether subject has ever had eye surgery.

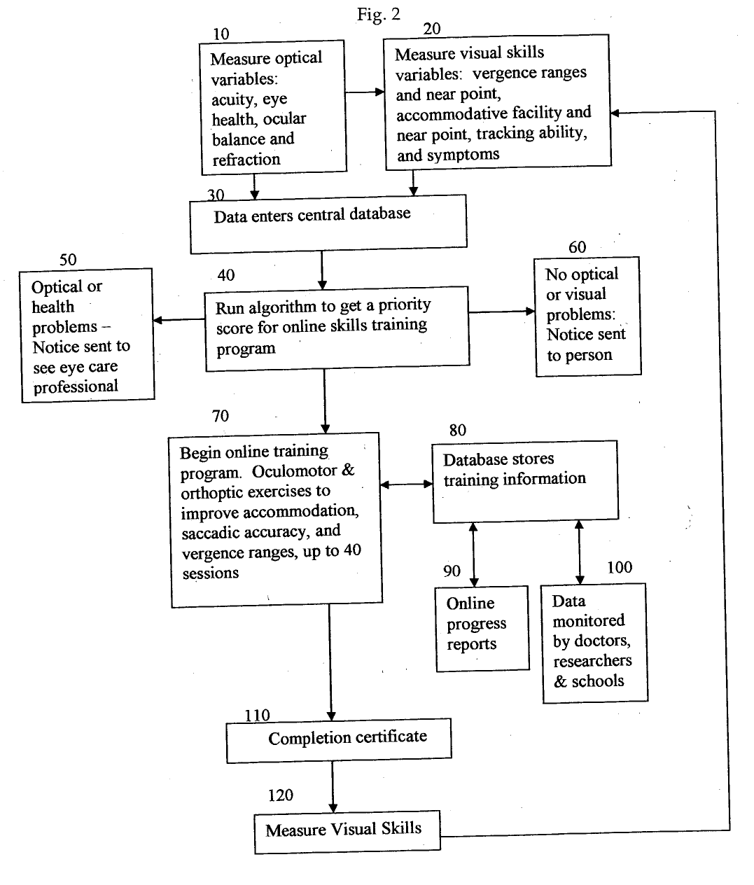

Typical optical measurements (see FIG. 2, block 10), such as distance visual acuity (with or without prescription), binocular balance at near and at far, refraction, exterior eye health, and an option to refer subject to doctor for optical or health problems.

Visual Teaming skill measurements, such as standardized clinical tests for convergence near point and vergence ranges. Three successive measurements are taken to assess how fatigue affects each subsequent measurement.

Visual Focusing skill measurements, such as standard clinical tests for accommodative near point (wherein three successive measurements are taken to assess how fatigue affects each subsequent measurement), and accommodative facility, which is assessed using +2.00/−2.00 accommodative flippers.

Visual Tracking skill measurements, such as a DEM (Developmental Eye Movement) test, which is a comparison of the subject's ability to read numbers rapidly and accurately when arranged in columns (an easy visual task) compared to reading numbers arranged as words in a book (a difficult visual task). This is a standardized developmental test. Optional Visagraph test may be given here as well.

Subjective information regarding symptoms experienced during reading, which may include: does subject experience headaches, pain or discomfort while reading? Does subject have double or blurry vision, hold books too close, see words jump around while reading, lose place on page while reading, and/or use their finger or other tool to keep their place while reading?

The Scantron form of FIGS. 3 and 4 leads the technician performing the screening to perform each test in the prescribed order. In an alternative embodiment, screening could be performed remotely, either by a qualified eye care practitioner, a trained individual, or by computerized means.

The next step is entry of the screening data into a central database. (FIG. 2, block 30). The dataset is preferably entered into the database through the use of the Scantron form described above, FIGS. 3 and 4. However, any data entry method such as a web form, fax form, bar code, doctor certification, OCR, manual or computerized entry and the like are appropriate. In addition to the method of entering data, the type of data entered may vary depending on the skills to be improved.

The next step (FIG. 2, block 40) is evaluation of the screening data by an algorithm. The algorithm has two parts. The first part indicates whether the subject should be referred to a doctor, and provides such a referral whenever any of the following conditions is met:

Visual acuity worse than 20/40 in either or both eyes;

Binocular balance vertical score higher than 2;

Tropia at either far or near;

A refractive error score of −1.00 D or higher at either 90 or 180 degrees in either eye;

A refractive error score of +2.00 D or higher at either 90 or 180 degrees in either eye;

A refractive error score difference, positive or negative, of 1.25 D or higher between 90 or 180 degrees in either eye;

A refractive error score difference, positive or negative, of 1.25 D or higher between the right eye and the left eye at either 90 or 180 degrees;

Any abnormal external eye health; or

An indication that the subject “always” experiences any of the following during reading: headaches, pain in the eyes, double vision, and the consistent need to blink.

The second part of the algorithm assesses visual skills, by assigning points to various test results. In one embodiment, points are assigned according to the following schedule:

///

///

///

///

| NAME | MAGNITUDE | POINTS |
|---|---|---|
| Phoria at near (Binocular Balance) | | |
| Esophoria | 2 to 4 PD | +1.0 |
| | 5 PD or more | °2.0 |
| Exophoria | 8 to 11 PD | +1.0 |
| | 12 PD or more | +2.0 |
| Vergences | | |
| Base In Break | 7 or 8 PD | +0.5 |
| | 6 PD or less | +1.0 |
| Base In Recovery | 5 or 6 PD | +0.5 |
| | 4 PD or less | +1.0 |
| Base Out Breal | 11 or 12 PD | +0.5 |
| | 10 PD or less | +1.0 |
| Base Out Recovery | 7 or 8 PD | +0.5 |
| | 6 PD or less | +1.0 |
| Near Point Convergence | 4 to 9 cm | +0.0 |
| | 10 to 13 cm | +0.5 |
| | 14 cm or greater | +1.0 |
| Accommodative Amplitude | 4 to 11 cm | +0.0 |
| | 12 to 14 cm | +0.5 |
| | 15 cm or greater | +0.0 |
| Flippers (Accommodative Facility) | 10 cpm or greater | +0.0 |
| | 7 to 9 cpm | +1.0 |
| | 6 cpm or lower | +2.0 |
| DEM (Developmental Eye | | |
| Movement) | | |
| Ratio | less than 1.24 | +0.0 |
| | 1.24 to 1.29 | +1.0 |
| | 1.30 or hogher | +2.0 |
| Errors | 3 or fewer | +0.0 |
| | 4 or 5 | +1.0 |
| | 6 or more | +2.0 |
| Symptoms | “Sometimes” or lower | +0.0 |
| | “Frequently” | +1.0 |
| | “Always” | +2.0 |

Using such a schedule, an algorithm generates a priority score for each subject, and that score is compared to a threshold number to determine which subjects should be referred for visual skills training. The threshold number will be determined by administrators and clinicians. For the schedule provided above, the threshold number could be 3, meaning that individuals with a score at or above that level likely have VIS, and could benefit from visual skills training. Of course, with limited resources it may not be possible to train every subject with VIS, so the scores can be used to rank students based on the severity of their visual skills deficiency, with the worst cases receiving priority for training. Additionally, subjects would not typically be referred to visual skills training based on subjective reports of symptoms alone, but instead would only be referred if the objective tests also indicate VIS.

Subjects may be notified of the screening results via the internet or through other conventional means such as telephone, written correspondence, or person to person communication with a school or organizational nurse, for example. If no optical or health problems were identified during screening, the individual may be notified of that fact too. See FIG. 2, block 60.

Additionally, a list of subjects diagnosed with VIS and the relative severity of each person's condition (represented by the priority score generated by the algorithm) may then be furnished to doctor's offices, schools or other organizations. From this list, the doctors or schools can select which subjects will participate in the online training modules.

Training Modules

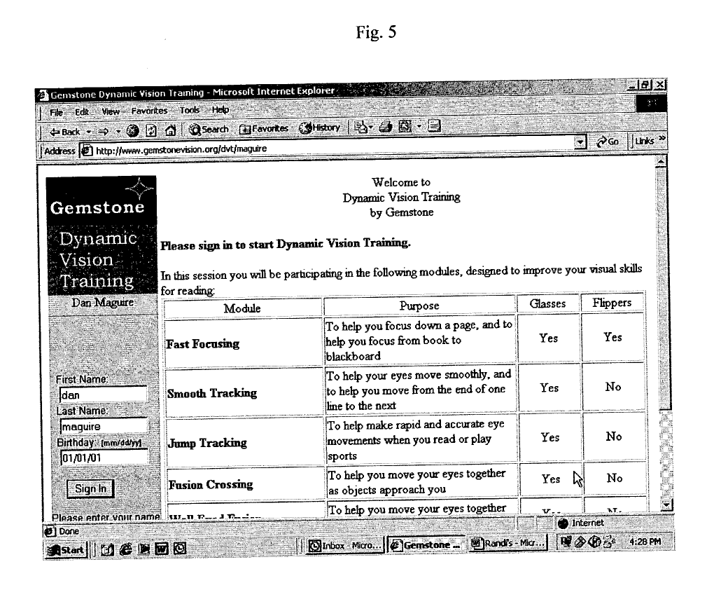

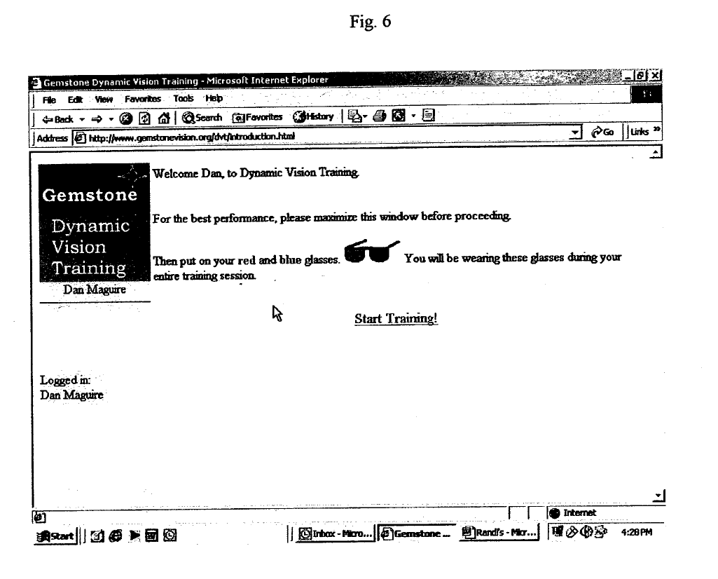

After consultation with the appropriate professional or team of professionals (doctors, educators, parents, etc.), the subject may enter visual skills training at block 70. If the online training program is approved, entry to the system is authorized and the subject receives necessary equipment, namely red and blue lenses (3-D glasses) and flippers, along with a password to enter the training system. See the login and post-login web pages shown in FIGS. 5 and 6. School or eye care personnel are trained so that they can assist in screenings and oversee online training sessions at schools or offices. Training can take place on existing school or office computers with network access. In addition, training can take place anywhere in the world—in the home, classroom or doctor's office, wherever there is access to the internet or other network system. For purposes of this patent, “network” is any data transmission system between two or more remote sites. This term includes but is not limited to the internet. The exercises can be conducted at any time during the day or night. However, it is preferred that the training take place at approximately the same time and place on a regular schedule.

The training is accomplished with software modules that present the subject with certain visual cues and then prompt the subject to respond to the cues, as described below. The software tracks correct and incorrect responses, along with the timing of responses. The resulting data is saved in a database on a remote server where experts can evaluate the results, identify users with significant problems, and recommend additional intervention to the user, See FIG. 1, block 80. Thus, throughout training, professionals monitor the subjects' progress remotely via the internet or other network system. Individuals get immediate feedback and can check scores online, as can parents. Problems and questions are dealt with immediately via email or telephone. There may be a 24-hour software support hotline. No special software needs to be installed on computers that access the system, other than a standard internet browser.

The exercises in the training modules provide therapy for the entire visual system, including exercises for improving the ability of the brain to control eye movement, eye alignment, focusing ability and endurance through repetition. In one embodiment, these vision-specific training exercises may be completed in no more than 40 daily sessions of approximately 20 minutes each. The internet browser may be Internet Explorer, although other browsers may be used as well. The visual skills training modules perform best when run on a computer with a relatively fast processor, such as a Pentium. Subjects may wear red and blue lenses (3-D glasses) over their regular glasses or contact lenses during all five modules, and each module may have a running time of around three minutes.

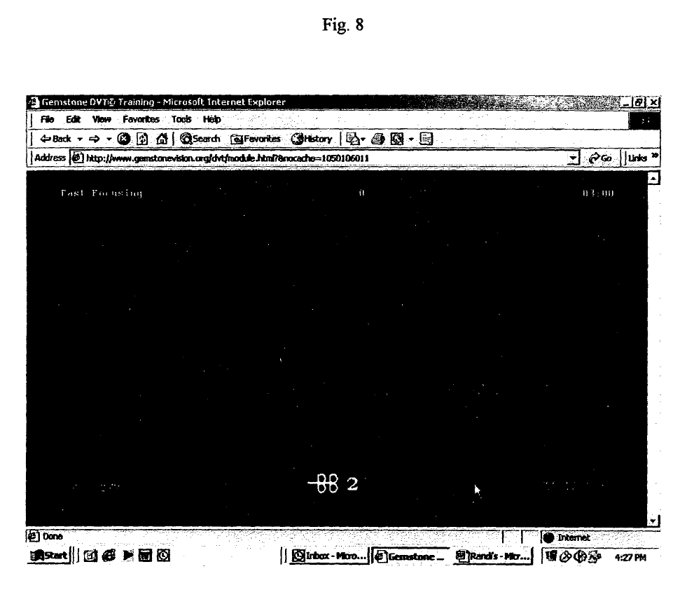

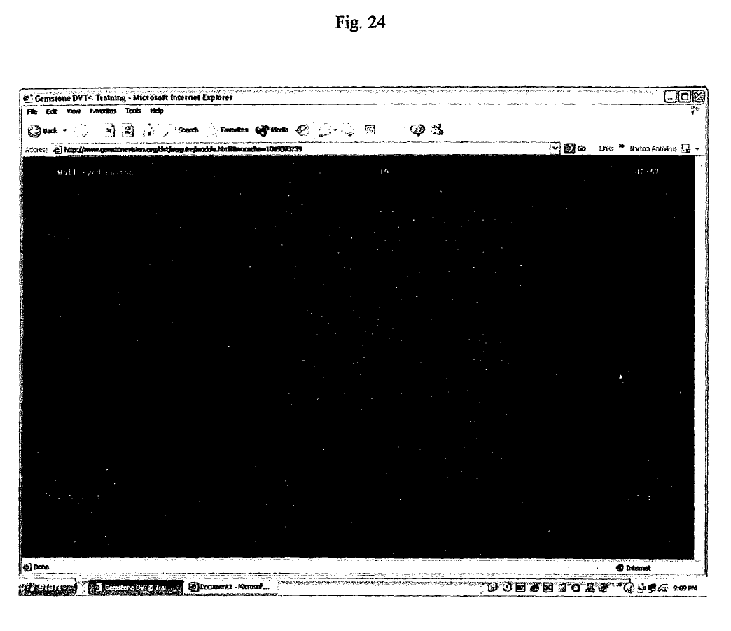

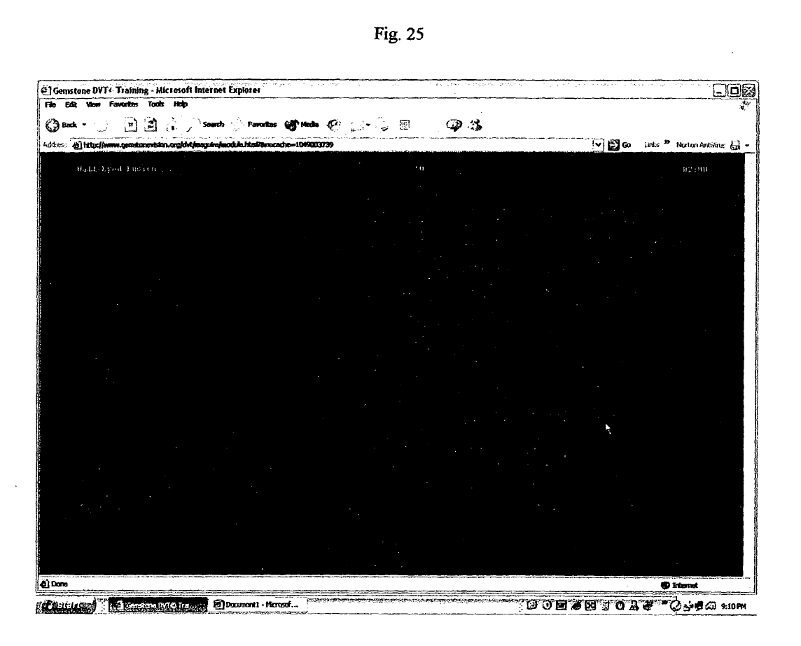

A module's training page is where the Java training applet runs. (The inventors of this patent have developed a copyrighted Java applet for this purpose). The training applet runs in a rectangular area in the center of the page. Above the training area, the following items may be displayed: subject's name, Score, and Time Remaining (counting down to zero). Below the training area, these items may be displayed: Module name, Flipper indicator, and Progress Meter. The Flipper indicator is an icon indicating whether the subject should be using the flipper glasses during this training. The Progress Meter indicates what module the subject is working on and how much more has to be done, (Module 2 of 5, for example). These aspects can be seen in the figures of the in-game screenshots, namely FIGS. 8, 9, 12, 13, 16, 17, 20, 21, 24, and 25.

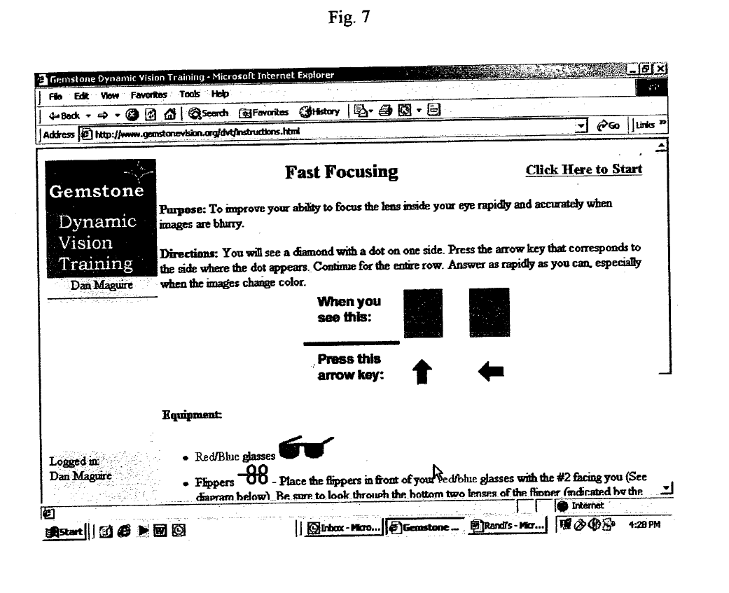

Each module may begin with an introductory instructions page, see FIGS. 7, 11, 15, 19, and 23. Subjects will be instructed as to how to use the flippers and the red and blue lenses and how to complete the training module. A specific description of each training module follows.

Sample Module 1: Fast Focusing

The first online visual skills training module, “Fast Focusing,” improves the visual skill known as accommodation, also known as dynamic focusing, accommodative amplitude and facility, and focusing. Using small detailed black glyphs on red and blue backgrounds, this module improves the ability to rapidly and accurately adjust the eye lens. For this exercise only, subjects hold the flippers in front of and directly next to the red and blue lenses in order to view the images displayed during the module. Flippers are a four-lensed apparatus that provides different focal lengths for training and screening users. The set of three flippers contains a total of six different focal length sets. The subject's score will determine which flipper lens set (#1 through #6) he or she should be using while performing this module. The flipper number at the bottom of the exercise screen should match the number that is facing the subject's nose as they hold the flippers next to the red and blue colored lenses (3-D glasses). The subject is instructed to sit up, at a proper reading distance from the computer monitor, and keep his or her head straight, moving only his or her eyes. The instructions web page for this exercise is shown in FIG. 7. The subject clicks on the “Click Here to Start” prompt to proceed to the module training screen.

///

///

Subjects will then see the training exercise screen. The glyphs are diamonds presented on a square red or blue background, with a single, tiny black dot placed randomly to the left, right, bottom or top point of the diamond. The red and blue backgrounds may appear on a black background.

On the first screen, FIG. 8, four glyphs are displayed on red backgrounds. The user strikes an arrow key matching the position of the dot. The glyph disappears. The user repeats for all four glyphs.

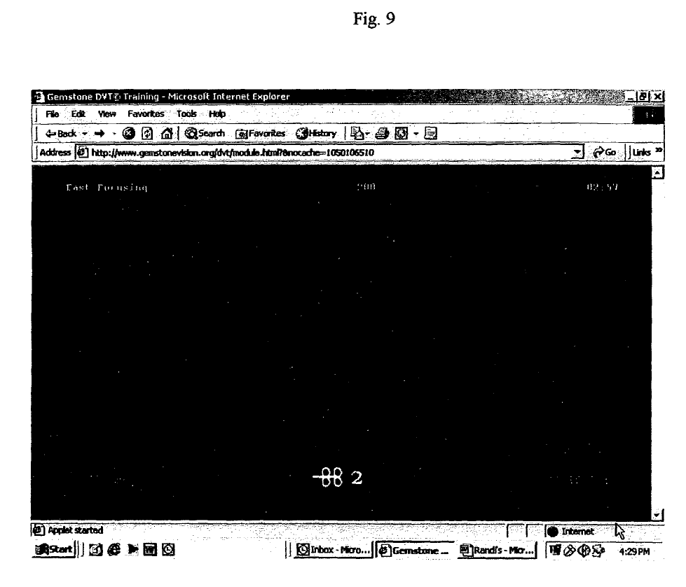

After all four glyphs disappear, four blue background glyphs appear. See FIG. 9. The user strikes an arrow key matching the position of the dot. The sequence repeats.

The program records the ability of the user to switch eyes (i.e., lens powers) and focus rapidly on the new glyph. It tracks the time and accuracy between the last glyph of one color to the first glyph of the next color. This is translated by an internal code into cycles per minute of accommodative function.

Sample Module 2: Smooth Tracking

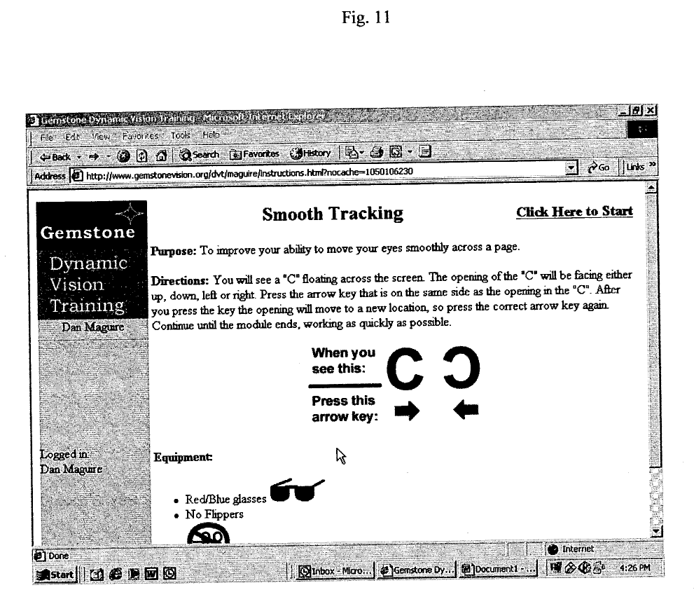

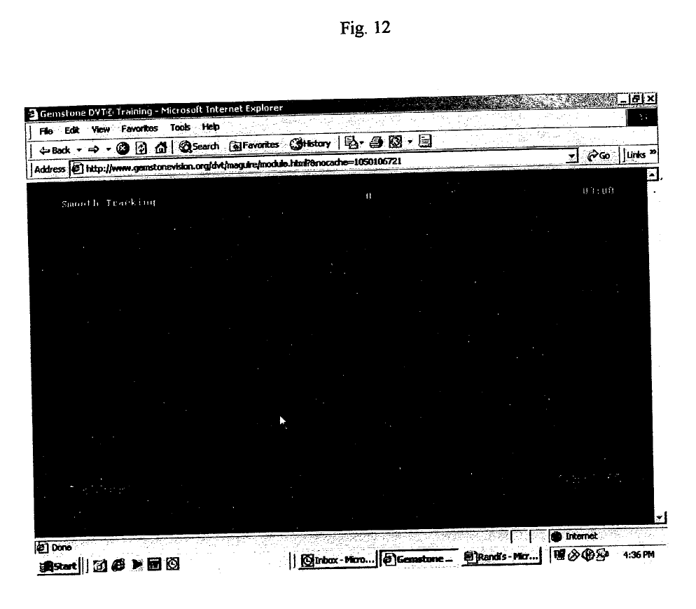

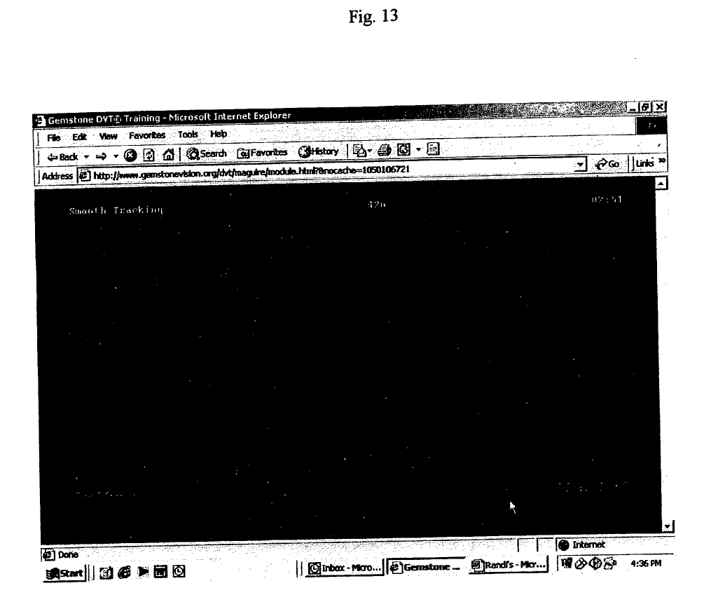

The second online visual skills training module in this embodiment, “Smooth Tracking,” improves the visual skill of Saccadic Accuracy, also known as saccadic tracking or tracking. This module improves subjects' ability to move their eyes smoothly across a page. Using a floating target, the ability of the user to track a target is trained. The floating target is a Landolt C. The opening of the “C” will be facing either up, down, left or right. The user strikes an arrow key matching the position of the opening of the “C.” See instructions web page, FIG. 11. The position of the “C” changes after each hit or miss. The color of the “C” is red for a certain number of hits or misses, followed by a set of blue, then a set of alternating red and blue. See FIGS. 12 and 13. The sequence repeats. In order to respond correctly, and thus improve the score, the subject's eyes must track the “C” as it changes from red to blue and as it floats across the screen. Each time the subject presses the correct arrow key corresponding to the location of the opening of the “C,” the subject's score increases.

Sample Module 3: Jump Tracking

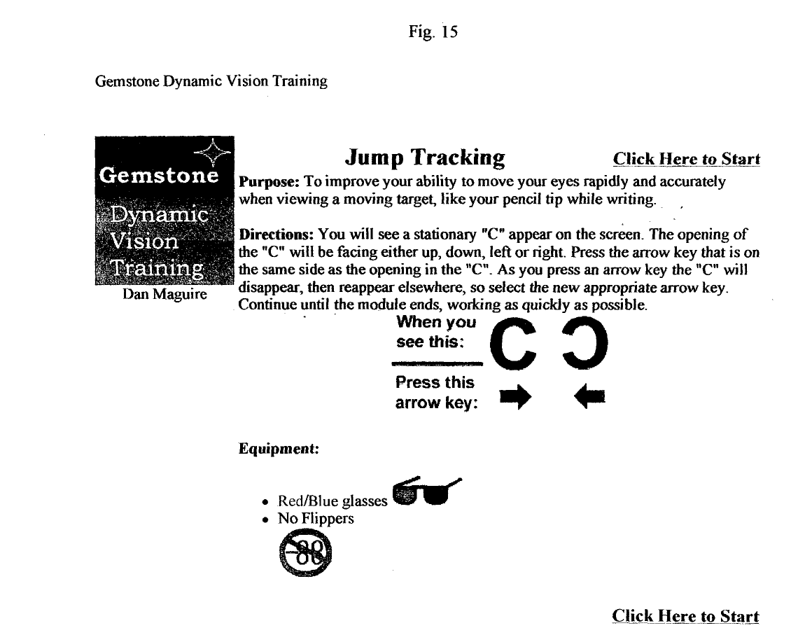

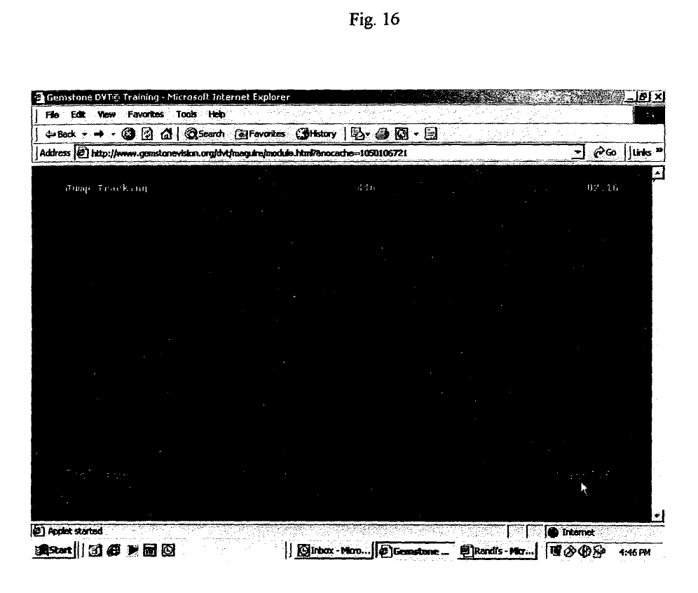

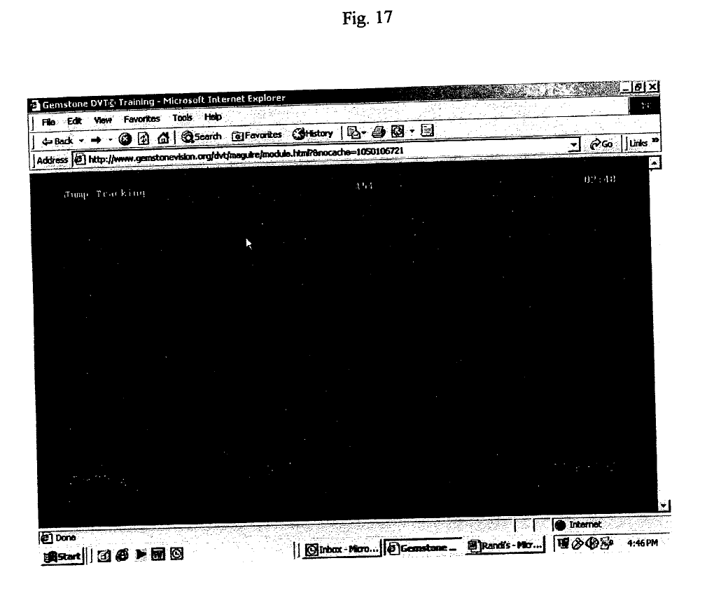

The third online visual skills training module, “Jump Tracking,” improves a different aspect of the same visual skill as the previous module, Saccadic Accuracy. Using a target that jumps between random positions, the ability to locate the target is tested. This module improves subjects' ability to move their eyes rapidly and accurately when viewing a moving target, like a pencil tip while writing. As in the previous module, the target is a Landolt C, wherein the opening of the “C” will be facing either up, down, left or right. The user strikes an arrow key matching the position of the opening in the “C.” See instructions web page, FIG. 15. The position of the opening changes after each hit or miss. Unlike the fluid movement of the “C” in the previous module, this “C” jumps statically from one place on the screen to another each time the student presses an arrow key. The “C” “jumps” instead of floats. The color of the “C” is red for a certain number of hits or misses, followed by a set of blues, then a set of alternating red and blue. See FIGS. 16 and 17.

Sample Module 4: Cross-Eyed Fusion

The fourth online visual skills training module, “Cross-Eyed Fusion,” uses three-dimensional random dot stereogram techniques to exercise inward muscular movements and identifies the range of capability of the user. This module improves subjects' ability to move their eyes together so that the brain can fuse separate images into one unified image wherever the eyes might move. In this module, the two eyes move toward the subject's nose, training the visual skill known as convergence, one aspect of the visual skill Vergence, also known as teaming.

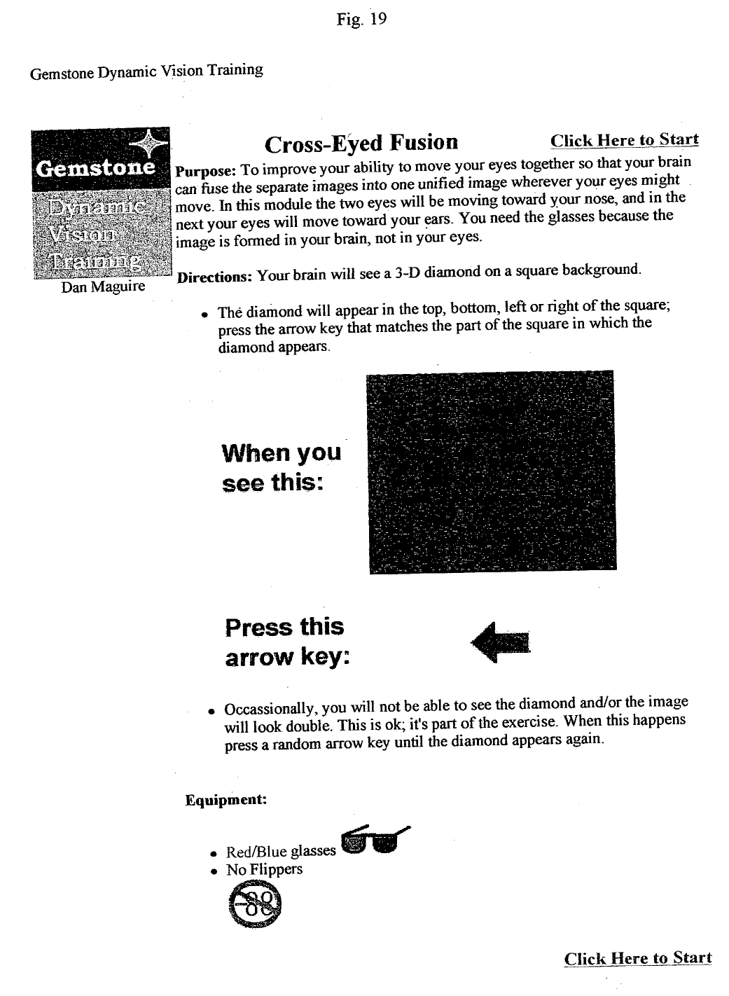

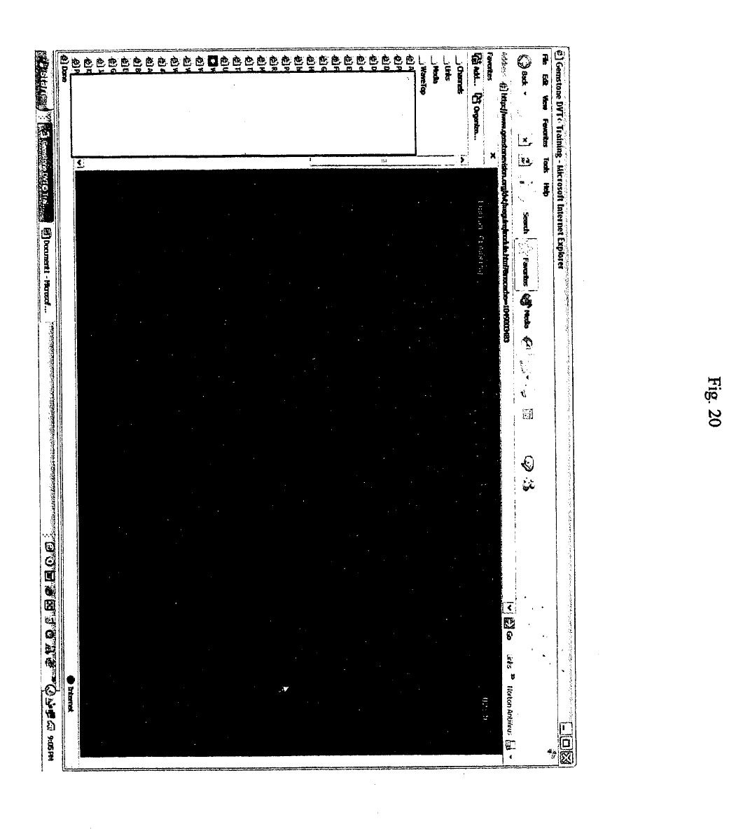

Three-dimensional (stereo) perception is stimulated by means of dichoptically presented red and blue background and foreground images that are overlaid, but may be stimulated by other means in different embodiments. See FIG. 19. The separation of the red and blue colors in the foreground image is always less than the separation of the red and blue colors in the background image. This results in a 3-D effect, when seen through red and blue tinted glasses. That is, initially, the subject will see the background rectangle composed of overlapping red and blue rectangles, as seen in FIG. 20. A three-dimensional diamond image appears in either the upper, lower, left or right side of the background rectangle. (The diamond is not viewable without the colored glasses and will not be visible in the Figs.) The subject's task is to indicate that he or she sees the foreground image in the appropriate location on the background. See screenshot of instructions web page, FIG. 19.

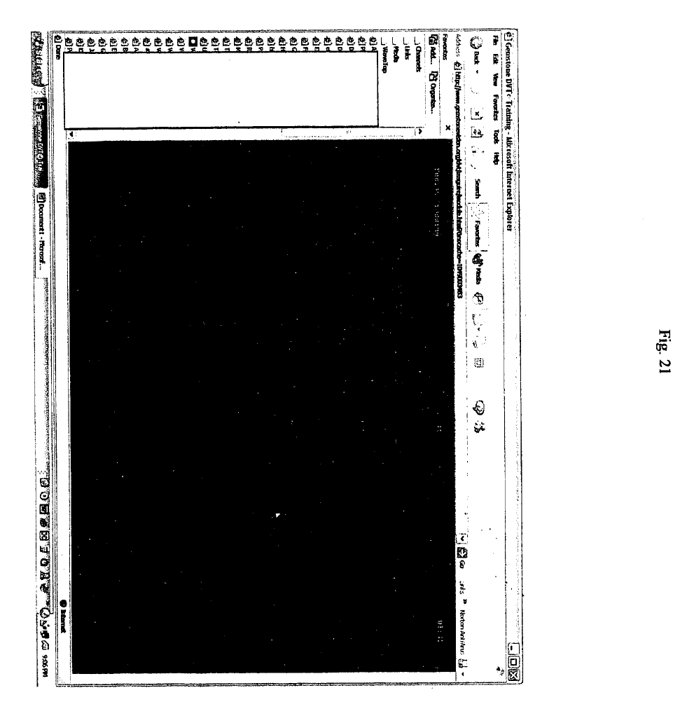

Successive presentations of the images have progressively smaller separation. Compare FIG. 20 to FIG. 21. As long as the user correctly identifies the position of the foreground image, the images continue to converge until the subject's maximum is reached (when fusion no longer occurs). As the images converge, the eyes move closer to the nose, and the 3-D image eventually becomes more difficult to see.

A “break” in convergence occurs when the subject can no longer see the 3-D image or the image doubles. At this point, the eyes have converged to their limit, and the brain is unable to fuse the separate images into one unified image. When the student enters an incorrect response, the foreground images are moved in the opposite direction until a correct response is obtained. That separation indicates “recovery” of convergence. When the user achieves target break and recovery values (measured automatically in diopters by the software), they proceed to the next level. As the levels increase, the images get smaller and more difficult to see.

Sample Module 5: Wall-Eyed Fusion

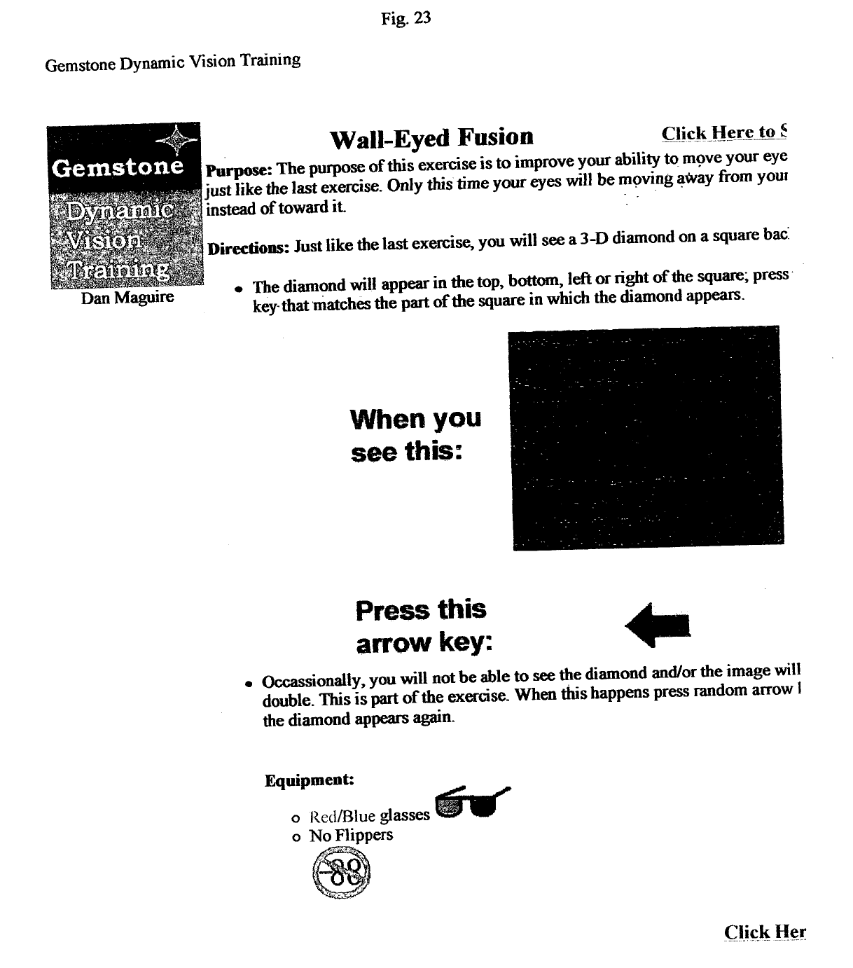

The fifth and final (for this embodiment) online visual skills training module, “Wall-Eyed Fusion,” also uses three-dimensional random dot stereogram techniques to improve the subjects' ability to move their eyes together so that the brain can fuse separate images into one unified image. However, this module exercises outward muscular movements while identifying the range of capability of the user. In this module, the two eyes move away from the student's nose, training the visual skill known as “divergence,” the second aspect of the visual skill Vergence, also known as teaming. See FIGS. 23, 24, and 25. To compare the two aspects of the visual skill Vergence, convergence trains convergent eye movement (i.e., movements of the eyes inward toward the nose), while divergence trains divergent eye movements (i.e., movements of the eyes outward toward the temples).

///

///

The only technical difference between the convergence and divergence modules (modules #4 and 5) is that the convergence images separate with the red image moving to the right while the blue image moves to the left. Compare FIGS. 20, 21, 24 and 25. As before, there will be a “break” in divergence when the subject can no longer see the 3-D image because the eyes have diverged to their limit, and the brain is unable to fuse the separate images into one unified image. The subject will enter incorrect responses, prompting the foreground images to move in the opposite direction. As the subject's eyes are brought back inward, toward the subject's nose, the subject will reach a “recovery” of divergence where the images are again visible. As in the previous module, when the user achieves target break and recovery values (measured automatically in diopters by the software), they proceed to the next level. As the levels increase, the images get smaller and more difficult to see. The maximum recovery and separation can be set differently. Convergence separations are generally higher.

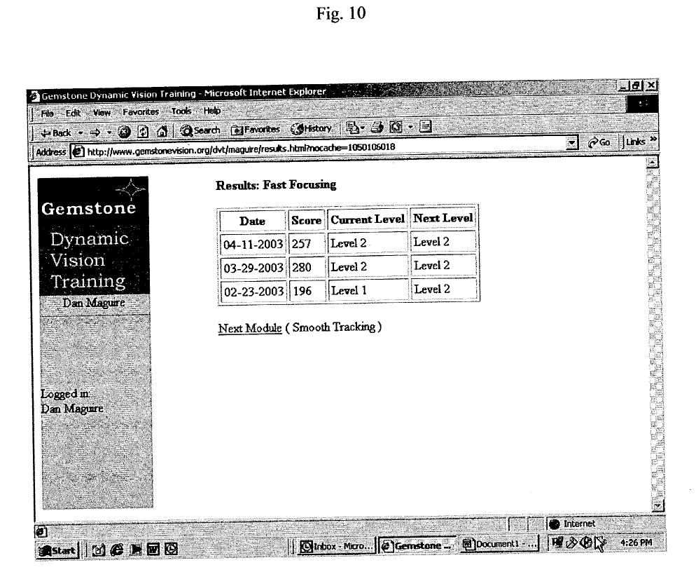

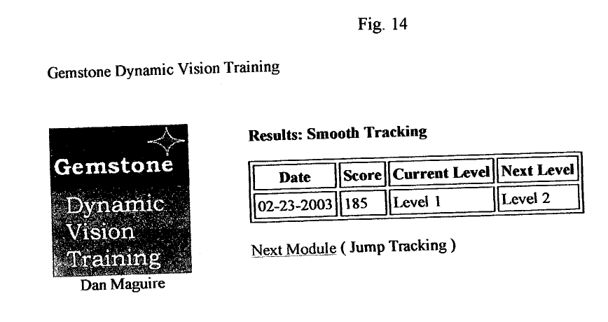

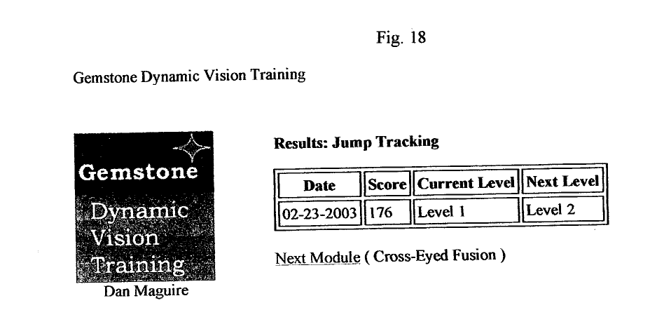

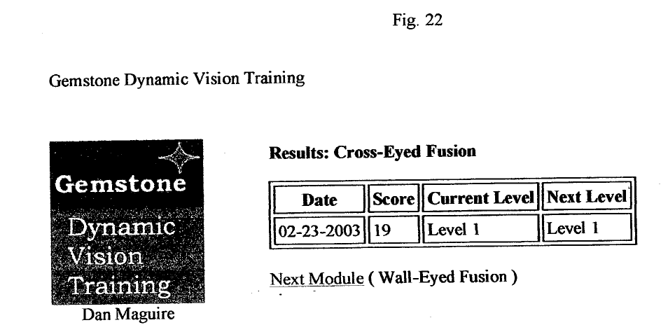

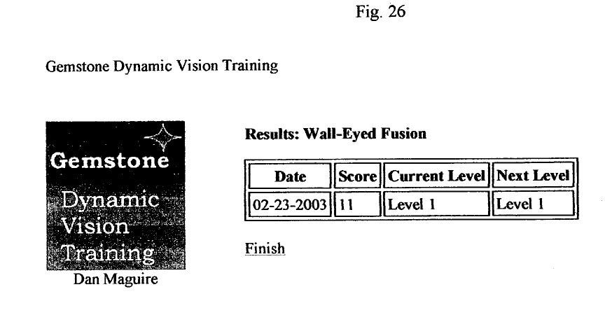

Each module runs for a certain preset but variable amount of time. When the time limit for each module expires, a results web page may display. See FIGS. 10, 14, 18, 22, and 26. It displays the date, the score, the current level and the level that the subject will automatically be presented in the next session. The subject may remain at the same level for multiple sessions if his or her score is not high enough to advance.

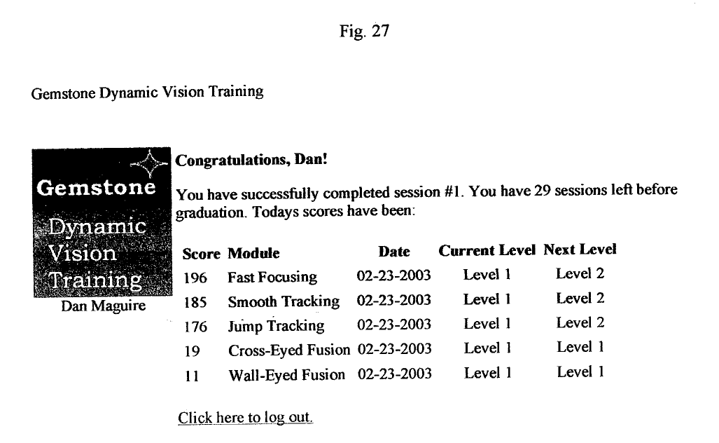

Once the subject completes the five training modules, a summary web page appears congratulating the subject on the work completed, FIG. 27. This screen tells the subject how many daily sessions remain before the subject completes the training program. This web page also summarizes the subject's scores and levels achieved during the training session just completed. Once the subject clicks on “finish,” he or she is not allowed to login to the training exercises for 24 hours. This prevents subjects from over-tiring or straining their eye muscles by doing the exercises too frequently. As with all muscle training, a period of recovery is essential to safe exercise.

///

///

///

///

///

Database

The centralized database is an essential feature of this invention. First, the database acts as a repository of information. FIG. 2, block 80. It may store such information as individuals' initial screening statistics, general academic and health records, online training scores and progress, as well as input from parents, doctors, and scientific literature. This collection of knowledge can be accessed remotely or otherwise by researchers, educators, and others. Second, as shown in FIG. 2, block 90, the database is a source of reports. Reports of any desired form are available remotely over the internet or other network system or in printed form, by querying the database. Third, as shown in FIG. 2, block 100, the database is a research tool. Physicians and administrators can monitor progress data of participating individuals. Individuals continue to train for the recommended number of sessions, which can be set and changed remotely by doctors. Thus, the database provides reports to the schools, allows professionals and parents to remotely monitor student's progress online, and organizes large amounts of stored information for researchers.

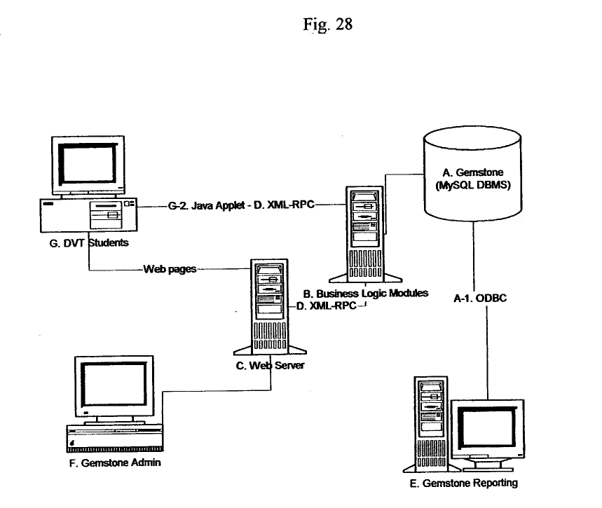

This invention may use a three-tier database-driven web interface architecture. FIG. 28 displays the conceptual layout of the system. The system may be comprised of three separate applications: a skills training application (FIG. 28G), an administrative interface application (FIG. 28F), and a reporting application (FIG. 28E).

A single database stores all information created on the system. The current implementation uses the MySQL DBMS, v3.23.42, using InnoDB table types. The DBMS has one database which may contain tables to organize information such as, but not limited to: applications, training modules, training results, training sessions, groups, schools, screening data, students and users. A description of these tables is presented in Appendix B. The DBMS is configured to listen for ODBC connections, providing read-only access to the database. The database schema is created using Alzabo.

///

///

///

///

///

Completion

Schools and parents may receive a full report on subjects' results to keep them informed about the subjects' visual health and academic performance. When a subject finishes the allotted number of daily training sessions, the initial screening examinations and drills are repeated to evaluate improvements in the subject's muscle strength and control. The same algorithm, FIG. 2, block 120, produces a new, post-training score for the subject. According to one trial, 72% of participants had adequate or superior visual skills when screened after six weeks of visual skills training. Additionally, they gained an average of 1.6 grade levels in reading efficiency, and some reported an improvement in vision-related sports, such as softball.

Graduates of the program may receive a signed certificate of completion, FIG. 2, block 110. If the score is not satisfactory, the program can be repeated any number of times by remote re-authorization.

Software Details

The software that implements the educational visual skills embodiment as described above includes a number of applications. The administrative application may have the following functions: input school roster, order screening, input Scantron results, view screening results, enroll students in visual skills training, and general data access using TRM. The administration, training or reporting application may be able to provide users with and/or perform the following functions: Web browser-enabled across the major platforms, integrated reporting module, track user sessions, handle school rosters, store data in a centralized database, high quality user experience, communicate with school data pieces, track students by grade level, automated screening data input, integrated billing module, integrated user management, 150,000 user base (current Linux Box), student work flow management, priority reports, pre/post results reporting, status reports, individual screening reports (student, teacher, doctor, human relations or vocational counseling specialist), and intuitive user training and “graduation” interface.

///

///

Additionally, the administrative, training or reporting application may be able to provide users with: proof-of-concept, organizational restructuring, screening methodology, ROI analysis, non-technical professional brochures for parents and students, computerized training for teachers and aides, legitimacy artifacts, and readiness-related support materials.

The software may run within a Web browser window, connected to the database system over the internet or other data transmission system. Remote software may be implemented for web-delivery using standard Java and HTML. Third party tools which may be necessary to run the software are listed in Appendix A.

The skills training application may break the existing monolithic Java application into smaller packages, which will decrease the download time of the software and improve the responsiveness for the skills training application. The skills training application requires a computing device with an appropriate web browser. To make use of the skills training application, the computer must be connected to a network, as defined above.

Business Logic Modules (BLM) are codes that directly communicate with the database that may reside in the Business Logic layer. This code builds an abstraction layer around the database, providing an object-oriented API specific to the needs of the system. The API is implemented as individual perl modules, referred to generally as Business Logic Modules, or BLMs. One BLM contains an heuristic/algorithm that analyzes student data to determine the need for a doctor referral.

One skilled in the art will appreciate that the present invention can be practiced by other than the preferred embodiments, which are presented for purposes of illustration and not of limitation.

[image]

[image]

[image]

[image]

[image]

We claim:

1. A method for assessing and treating a sensory/perceptual skills deficiency, comprising:
evaluating subjects' skills in a particular sensory/perceptual field;
referring subjects to training based on said evaluation;
using an interactive network-based training module to improve the skills of the referred subjects in said particular sensory/perceptual field;
generating training data from the use of said network-based training module by said referred subjects; and
uploading said training data to a centralized, network-accessible database.

2. The method according to claim 1, wherein said network is the internet.

3. The method according to claim 2, wherein said particular sensory/perceptual field is visual skills.

4. The method according to claim 3, additionally comprising generating assessment data from the step of evaluating subjects' skills in a particular sensory/perceptual field, and uploading said assessment data to said database.

5. The method according to claim 4, additionally comprising making said database accessible to researchers for study.

6. The method according to claim 5, wherein said training module comprises training to improve saccadic accuracy.

7. The method according to claim 6, additionally comprising a second training module to improve vergence skills.

8. The method according to claim 7, additionally comprising the step of using an interactive internet module to obtain feedback on the subject's performance in at least one of said training modules.

9. The method according to claim 8, additionally comprising a third training module to improve accommodation skills.

10. The method according to claim 9, wherein colored 3-D glasses are used.

11. The method according to claim 10, wherein lenses are used.

12. The method according to claim 11, wherein said database is remote from the place where said training modules are used.

13. The method according to claim 11, wherein the step of referring subjects to training based on said evaluation comprises:
using an algorithm to generate a priority score for each subject based on the results of the step of evaluating subjects' skills in a particular sensory/perceptual field; and
comparing said priority score to a predetermined threshold.

14. The method according to claim 13, additionally comprising generating reports from said database to track the progress of a particular subject through said training modules.

15. A system for the assessment and training of sensory/perceptual skills, comprising:
an assessment module for determining whether a subject has a deficiency in a particular set of sensory/perceptual skills;
an interactive, network-based training module for training said subject to improve said particular set of sensory/perceptual skills;
a centralized, remotely-accessible database for receiving data from said assessment module and said training module.

16. The system according to claim 15, wherein said network is the internet.

17. The system according to claim 16, wherein said particular set of sensory/perceptual skills is the set of visual skills that includes saccadic accuracy, accommodation, and vergence.

18. The method according to claim 17, wherein said database is accessible to researchers for study.

19. A method for assessing and improving a subject's visual skills of saccadic accuracy, vergence, and accommodation, comprising:
evaluating the subject's saccadic accuracy, vergence, and accommodation skills;
developing a visual skills score for the subject based on the evaluation of the subject's saccadic accuracy, vergence, and accommodation skills;
uploading the subject's biographic data and visual skills score to a centralized, remotely accessible database;
referring the subject to training when the score exceeds a threshold;
improving the subject's saccadic accuracy, vergence, and accommodation skills using a series of interactive, internet-based training modules;
generating training data based on the subject's progress in using said training modules;
uploading said training data to said database; and
making said database available over the internet to researchers and clinicians.

20. The method according to claim 19, wherein a customized Scantron form is used in evaluating the subject's saccadic accuracy, vergence, and accommodation skills.

21. The method according to claim 20, where the subject uses lenses and 3-D glasses when using said series of interactive, internet-based training modules and lenses.
